(19) United States
(12) Patent Application Publication
(10) Pub. No.: US 2024/0369414 A1
(43) Pub. Date: Nov. 7, 2024

(54) THERMAL IMAGING INCLUDING AN EXTENDED SHORT WAVE INFRARED LIGHT SOURCE TO IDENTIFY AN OBJECT

(71) Applicant: LightPath Technologies, Inc., Orlando, FL (US)

(72) Inventors: Shmuel RUBIN, Winter Park, FL (US); Edward FOOTE, Winter Springs, FL (US)

(73) Assignee: LightPath Technologies, Inc., Orlando, FL (US)

(21) Appl. No.: 18/651,613

(22) Filed: Apr. 30, 2024

Related U.S. Application Data
(60) Provisional application No. 63/463,412, filed on May 2, 2023.

(51) Int. Cl. G01J 5/0801; G01J 5/00; G01J 5/08; H04N 5/33; H04N 23/23

(52) U.S. Cl. CPC G01J 5/0801; G01J 5/0859; H04N 5/33; H04N 23/23; G01J 2005/0077

(57) ABSTRACT

An infrared imaging system includes a detector configured to detect wavelengths in a first infrared wavelength band and a second infrared wavelength band, shorter than the first infrared wavelength band, a light source configured to output light in the second infrared wavelength band to an object, and an identify circuit configured to identify the object based on spectral characteristics of light returned from the object detected by the detector. The second infrared wavelength band is an extended short wavelength infrared band.

### CROSS-REFERENCE TO RELATED APPLICATION

The present application claims priority to Provisional Ser. No. 63/463,412 filed on May 2, 2023, the entire contents of which are incorporated herein by reference.

### BACKGROUND

### Field

The present disclosure relates to imaging in using a specific wavelength in the extended short wave infrared band and identify the object based on optical characteristics from being illuminated by the extended short wave infrared band.

### Description of the Related Art

Different infrared wavelength bands are used for different purposes. For example, infrared detectors include those for a near infrared (NIR) wavelength band (0.75 μm to 1.4 μm), for a short wavelength infrared (SWIR) wavelength band (1.4 to 3 μm), for a mid wavelength infrared (MWIR) wavelength band (3.0 to 5.0 μm) is, and for a long wavelength infrared (LWIR) wavelength band (8.0 to 12 μm) is. Typically, SWIR imaging systems image in the wavelength band of 1.4 to 2.0 μm and extended SWIR (eSWIR) imaging systems image in the wavelength band of 2.0 to 3.0 μm. In general, infrared imaging up to 2.5 μm images reflected light from an object and infrared imaging above 3.0 μm images emitted light from an object.

### SUMMARY

One or more embodiments is directed to an infrared imaging system, including a detector configured to detect wavelengths in a first infrared wavelength band and a second infrared wavelength band, shorter than the first infrared wavelength band, wherein the second infrared wavelength band is an extended short wavelength infrared band, a light source configured to output light in the second infrared wavelength band to an object, and an identify circuit configured to identify the object based on spectral characteristics of light returned from the object detected by the detector.

One or more embodiments is directed to a method of detecting an infrared image, including providing a detector for detecting a thermal image of an object, the detector configured to detect wavelengths in a first infrared wavelength band, the detector having a field of view, illuminating at least a portion of the object with a second infrared wavelength band, shorter than the first infrared wavelength band, and identifying the object based on spectral characteristics of light returned from the object detected by the detector.

### BRIEF DESCRIPTION OF THE DRAWINGS

FIG. 1 illustrates a schematic side view of an imaging system according to an embodiment.

FIG. 2 illustrates a schematic side view of an imaging system according to an embodiment.

FIG. 3 illustrates use of the imaging system according to FIG. 1 or FIG. 2 with an object.

FIG. 4 illustrates a spectral response of a camera for use in the imaging system.

FIG. 5 is an output of the camera in the imaging system in which the reflected light and the thermal image are imaged at the same time.

FIG. 6 illustrates use of an imaging system according to an embodiment with an object.

FIG. 7 illustrates a schematic side view of an imaging system according to an embodiment.

FIG. 8 illustrates use of an imaging system according to an embodiment with an object.

The scope of the present disclosure is best understood from the following detailed description of exemplary embodiments when read in conjunction with the accompanying drawings.

### DETAILED DESCRIPTION

Analyzing reflected illumination for MWIR or LWIR imaging to identify an object is typically not effective, given the poor reflectance at these wavelengths. However, in accordance with embodiments, by using a camera that can detect in both the MWIR or LWIR and the eSWIR wavelength bands, identifying an object based on reflection at a specific wavelength of the eSWIR wavelength band may be used to identify objects imaged using higher wavelength band systems may be realized. In other words, an imaging system according to embodiments may be used to image both emissive heat and reflected light. Additionally, as disclosed in U.S. application Ser. No. 18/600,232, filed Mar. 8, 2024, and entitled “THERMAL IMAGING INCLUDING AN EXTENDED SHORT WAVE INFRARED LIGHT SOURCE,” incorporated herein by reference for all purposes, the eSWIR may be used generally to target the object as well as using a specific wavelength of the eSWIR to identify the object.

Thus, one or more embodiments are directed to detecting a specific wavelength that can be reflected by the object, that is readable by thermal imaging systems having a particular spectral response, but not readily detected by other thermal imaging systems and is outside the spectral region to be used to detect the thermal image, and identifying the object based on an intensity of the specific wavelength or spectral characteristics (spectra) of specific light reflected by the object. Other embodiments are directed to identifying an object based on absorption of the eSWIR that increases the emissive heat emitted therefrom. Finally, other embodiments are directed to using either identification technique and further illuminating the object to increase the emissive heat emitted therefrom.

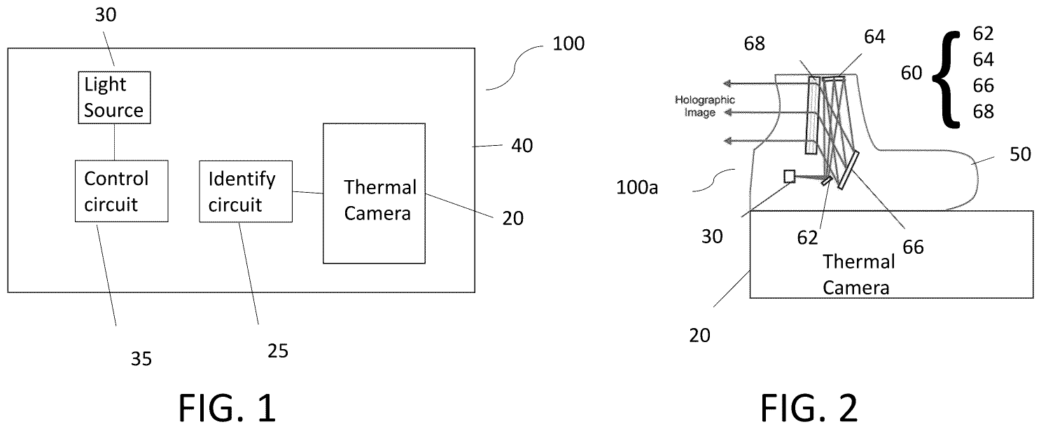

As shown in FIG. 1, an imaging system 100 according to an embodiment includes a camera system 110 having broadband thermal camera 20 for detection in the LWIR (and/or MWIR) and eSWIR range and a light source 30 that emits light in the eSWIR range. As a particular example of such a broadband thermal camera 20 includes an uncooled LWIR bolometer manufactured by LightPath Technologies®, e.g., the Multispectral Infrared Camera MANTIS™.

An identify circuit 25 for determining whether an amount of light reflected by an object in a particular portion of the eSWIR range exceeds a threshold and identify or classify the object based on whether the threshold is exceeded or not. In particular, if the threshold is exceeded, the object is identified. Details of such detection are disclosed, e.g., in Wiley, L. et al., “Target discrimination in the extended SWIR (eSWIR) band (2-2.5 μm) compared to Vis, NIR, and SWIR in degraded visual environments” Proc. SPIE 12106, Infrared Imaging Systems: Design, Analysis, Modeling, and Testing XXXIII, 1210606 (27 May 2022).

In particular, in order to identify a friend or one's own objects, these objects may have at least a portion thereof painted with a paint that has a distinctive spectral signature. By utilizing the infrared, and specifically the region of the infrared not commonly used (2-3 um), that adversaries would not use and such painting would not be apparent from visual inspection of the objects.

Alternatively or additionally, friendly objects, e.g., vehicles, soldiers and devices, may be provided with reflectors that reflect only a very specific wavelength, e.g., 2.7 um, that is not conventionally imaged, but that can be imaged with a camera that is specifically sensitive to that wavelength. By having a selective reflector such as a retroreflector cube, or array of such corner cubes, one can use a laser at that exact wavelength and scan an area looking for that exact reflection, in order to identify a friendly object.

A control circuit 35 for controlling the light source may be used to control illumination of light output by the light source 30 to illuminate a portion of an object to be imaged by the camera 20. The control circuit 35 may scan the light output by the light source 30 to illuminate an entirety of a field of view of the camera 20 or may scan the light output by the light source 30 to illuminate subsets of the object sequentially. Alternatively or additionally, the control circuit 35 may control scanning based on a position of the object. Alternatively or additionally, the control circuit 35 may control a wavelength to be output by the light source 30 and/or an intensity to be output by the light source 30 to pulse the light output by the light source 30. The control circuit may also be in communication with the camera 20 to synchronize detection of the light with the output of the light source 30. The control circuit 35 may be provided in the housing 40, incorporated with the thermal camera 20, or remote therefrom but in communication with the light source 30 and/or the camera 20.

The imaging system 100 illustrates that the camera 20 and the light source 30 may be integrated in a single housing 40. Alternatively, as shown in FIG. 2, an imaging system 100a may include the light source 30 in a separate housing 50 from the thermal camera 20 and may include additional optics 60 to generate a holographic image to be reflected from an object. For example, the optics 60 may include a first mirror 62 to direct light from the light source 30 to a collimating reflector 64, which collimates light onto a holographic grating 66, which reflects light onto a reticle image hologram 68 to output the holographic images. The optics 60 may also be included in the housing 40. Such holographic sights are known, e.g., in U.S. Pat. No. 6,490,060 B1, which is hereby incorporated by reference in its entirety for all purposes. Again, the control circuit 35 may be provided in the housing 50, incorporated with the thermal camera 20, or remote therefrom, but in communication with, the light source 30.

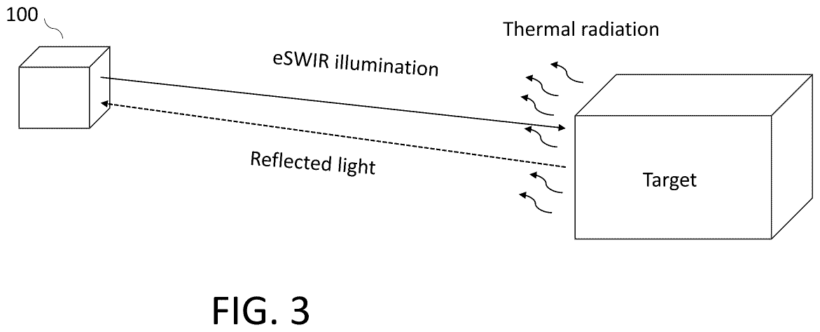

When serving as a sight, e.g., on a gun, the light source 30 is collimated and aligned together with the camera 20 so that the light source can be used to target the gun, while seeing the laser spot reflected together with the thermal image. An example of using either configuration is shown in FIG. 3. As may be seen therein, the imaging system 100 (or 100a) illuminates an object with eSWIR illumination output from the light source 30, as indicated by the solid line. This eSWIR illumination is reflected by the object back to the imaging system 100, as indicated by the dashed line. The imaging system 100 also images the thermal image from the object, as indicated by the wavy lines. Thus, the reflection from an object may serve both as a sight and, based on an intensity of light or spectra of specific light received by the camera, to identify the object.

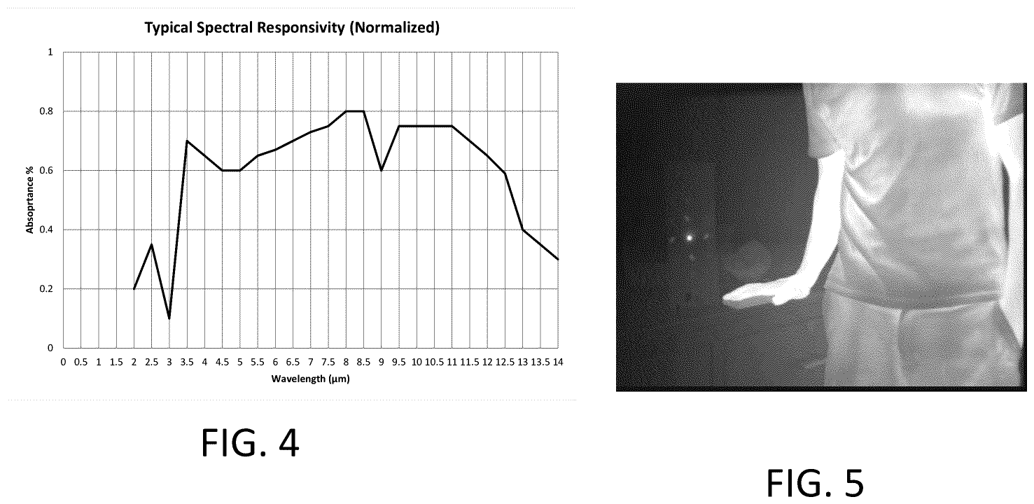

The exact wavelength to be output by the light source 30 depends on the spectral response of the camera 20. For example, the Multispectral Infrared Camera MANTIS™ has a spectral response as shown in FIG. 4. As may be seen therein, in the eSWIR region, this particular camera has a peak response around 2.3 μm. Response shown in FIG. 4 is a typical spectral response, however, peak wavelengths may vary +/−0.5 μm. Therefore, a light source 30 outputting this wavelength may be used in conjunction with this particular camera 20. The light source 30 may be a gallium antimonide (GaSb) laser. Alternatively or additionally, the light source 30 may be a high-power light source emitting light in the range of 2-3 um to illuminate the environment surrounding the object such that a dual band or multispectral detector can image both the light reflected from the surrounding environment and the thermal image.

As may be seen in FIG. 5, when such a laser is used as the light source 30 with this particular camera 20, the camera 20 may detect both a thermal image and the reflected light at the same time. The reflected light may be used both as a sight and to identify the object.

Alternatively, if the friendly object includes at least a portion thereof that absorbs highly in the eSWIR, the increased emittance from the object may be used to identify the object. Thus, the reflected light may still be used for targeting and an increase in emittance may be used to identify the object.

Thus, instead of relying on the reflective characteristics of a material to identify an object, the object may be made of a material or including a portion that absorbs the eSWIR light This is in particular the case with some plastics, illumination from the light source, e.g., a pulsed laser, at a wavelength of 2 um or 2.3 um (or other wavelengths in the eSWIR range) gets absorbed by the plastic, heating it up to increase the thermal radiation emitted therefrom, sometimes within seconds. Thus, a thermal imaging camera 20 can better image the object as well as identify the object as friendly when in absorbs such illumination.

With this method, by heating up or marking an object that otherwise might not be generating enough heat to be detected by the thermal camera 30, allows existing other thermal cameras that are limited to the detection of standard LWIR and\or MWIR wavebands, to better image an object that otherwise might not be hot enough to be imaged.

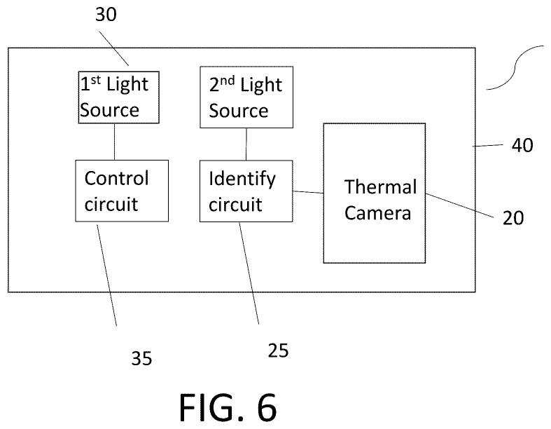

In yet another embodiment, an imaging system 200 includes a camera system 210 including the thermal camera 20 and the identify circuit 25, without the light source 30 and the control circuit 35, and a light source 130 that are not at a same location as each other or as an object. As may be seen in FIG. 6, again, instead of light source being on camera system 210, the light source 130 is incorporated in or attached to a device 310, e.g., a device worn by or carried by a person, a vehicle, e.g., an unmanned aerial vehicle, and so forth, different from the object, to serve as a laser designator to illuminate the object. In other words, the light source 130 is at a location separate from both the camera 20 and the object, e.g., a person may illuminate the object for detection by a thermal camera remote from the person, e.g., in a vehicle or used by another person, or the light source may be in a vehicle to light up the object for the detection by one or more thermal cameras not on the vehicle.

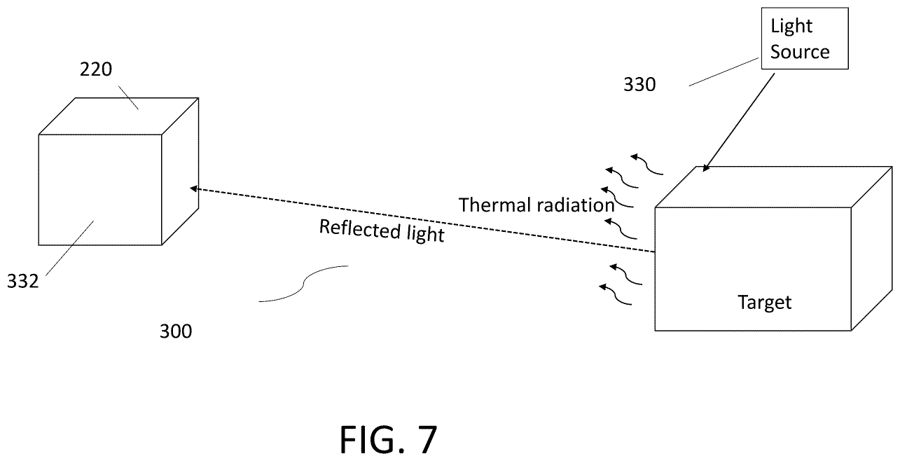

In another embodiment, the illumination system may include two light sources, co-aligned, output from a common aperture. For example, a first light source, e.g., a 2-2.5 um laser, may be used to identify a reflective sample, while a high-power laser in another wavelength (such as a CO2 laser at 10.6 μm), is used to heat up the object, so that a standard thermal camera can better image the object. This method allows to heat up an object that is reflective in the range of the first laser, but absorbs the wavelength of the second laser. As may be seen in FIG. 7, an imaging system 300 includes a camera system 310, which includes the thermal camera 20, the identify circuit 25, the first light source 30, the control circuit 35, and a second light source 70. The second light source 70 may output illumination in response to the identify circuit 25 identifying the object.

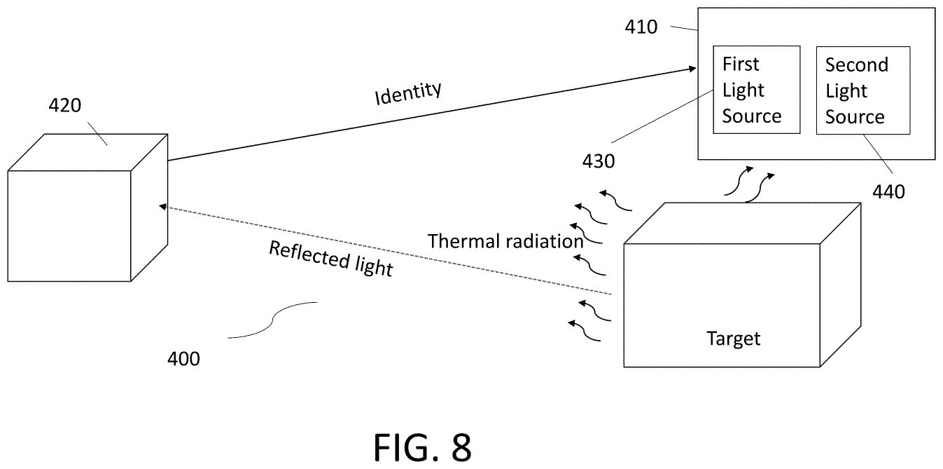

In yet another embodiment, as shown in FIG. 8, an imaging system 400 may include the first and/or second light source may be in a device 410 remote from the camera system and the object. In the imaging system 400, a camera system 410 includes the thermal camera 20 and the identify circuit 25, without the light source 30 and the control circuit 35, and/or without the second light source 70. A device 510 includes a first light source 130 and/or a second light source 170. When the device 510 includes the second light source 170, a communication link between the identify circuit 25 in the camera system 410 and the device 510 is provided to control the second light source 170.

The present disclosure is not limited to only the above-described embodiments, which are merely exemplary. It will be appreciated by those skilled in the art that the disclosed systems and/or methods can be embodied in other specific forms without departing from the spirit of the disclosure or essential characteristics thereof. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise indicated. The presently disclosed embodiments are therefore considered to be illustrative and not restrictive. The disclosure is not exhaustive and should not be interpreted as limiting the claimed invention to the specific disclosed embodiments. In view of the present disclosure, one of skill in the art will understand that modifications and variations are possible in light of the above teachings or may be acquired from practicing of the disclosure. The scope of the invention is indicated by the appended claims, rather than the foregoing description.

1. An infrared imaging system, comprising:
a detector configured to detect wavelengths in a first infrared wavelength band and a second infrared wavelength band, shorter than the first infrared wavelength band, wherein the second infrared wavelength band is an extended short wavelength infrared band;
a light source configured to output light in the second infrared wavelength band to an object; and
an identify circuit configured to identify the object based on spectral characteristics of light returned from the object detected by the detector.

2. The infrared imaging system of claim 1, wherein the light source illuminates an entire field of view being imaged by the detector with the second infrared wavelength band.

3. The infrared imaging system of claim 1, further comprising a scanner to scan light output by the light source to illuminate a portion of the object being imaged by the detector.

4. The infrared imaging system of claim 3, wherein the scanner is to scan the light output by the light source to illuminate an entirety of the object simultaneously.

5. The infrared imaging system of claim 3, wherein the scanner is to scan the light output by the light source to illuminate subsets of the object sequentially.

6. The infrared imaging system of claim 1, wherein the identify circuit is configured to identify the object based on an intensity of specific light in the second infrared wavelength band.

7. The infrared imaging system of claim 1, wherein the identify circuit is configured to identify the object based on an intensity of specific light in the first infrared wavelength band.

8. The infrared imaging system of claim 1, further comprising a control circuit configured to control the light source to output a selected wavelength in the second infrared wavelength band.

9. The infrared imaging system of claim 1, wherein the light source is further configured to output light in the first infrared wavelength band based on the identity of the object.

10. The infrared imaging system of claim 9, wherein the light source illuminates an entire field of view being imaged by the detector with the first infrared wavelength band.

11. The infrared imaging system of claim 10, wherein the light source illuminates less than the entire field of view being imaged by the detector with the first infrared wavelength band.

12. A method of detecting an infrared image, comprising:
providing a detector for detecting a thermal image of an object, the detector configured to detect wavelengths in a first infrared wavelength band, the detector having a field of view;
illuminating at least a portion of the object with a second infrared wavelength band, shorter than the first infrared wavelength band; and
identifying the object based on spectral characteristics of light returned from the object detected by the detector.

13. The method of claim 12, wherein the second infrared wavelength band is an extended short wavelength infrared band.

14. The method of claim 13, wherein the first infrared wavelength band is a long wave infrared wavelength band.

15. The method of claim 12, wherein illuminating the object includes scanning illumination across the object.

16. The method of claim 12, wherein identifying the object is based on an intensity of specific light in the first infrared wavelength band.

17. The method of claim 12, wherein identifying the object is based on an intensity of specific light in the second infrared wavelength band.

18. The method of claim 12, wherein illuminating is in a selected wavelength in the second infrared wavelength band.

19. The method of claim 12, further comprising, in response to the object being identified, outputting light in the first infrared wavelength band.
